(19) United States
(12) Patent Application Publication
(10) Pub. No.: US 2016/0308889 A1
(43) Pub. Date: Oct. 20, 2016

(54) METHODS AND SYSTEMS FOR SELF-DETECTION OF POST-PRODUCTION EXTERNAL HARDWARE ATTACHMENTS

(71) Applicant: Temporal Defense Systems, LLC, Renton, WA (US)

(72) Inventors: Ronald Lance Justin, Santa Barbara, CA (US); Charles Elden, Dunnellon, FL (US); Jared Karro, Charlotte, NC (US); Mark Tucker, Kirkland, WA (US)

(21) Appl. No.: 15/130,507

(22) Filed: Apr. 15, 2016

Related U.S. Application Data
(60) Provisional application No. 62/148,551, filed on Apr. 16, 2015.

(51) Int. Cl. H04L 29/06

(52) U.S. Cl. CPC H04L 63/1416

(57) ABSTRACT

Systems and methods described herein may detect hardware modifications. A test loop may terminate at a transmit pin and a receiver pin of a processor footprint pad. A processor may be coupled to the test loop via the transmit pin and the receiver pin. The processor may cause a signal to be transmitted to the test loop from the transmit pin and receive a modified signal from the test loop at the receiver pin. The processor may analyze the modified signal to detect a hardware modification in communication with the test loop based on the modified signal.

### CROSS-REFERENCE TO RELATED APPLICATIONS

This application is based on and derives the benefit of the filing date of U.S. Provisional Application No. 62/148,551, filed Apr. 16, 2015. The entire content of this application is herein incorporated by reference in its entirety.

### BRIEF DESCRIPTIONS OF THE DRAWINGS

FIG. 1 illustrates a hardware man in the middle implementation.

FIG. 2 illustrates a standard processor mount and a hardware man in the middle implementation mount.

FIG. 3 illustrates a processor comprising self-detection features according to an embodiment of the invention.

FIG. 4 illustrates a test loop for performing a hardware man in the middle propagation delay test according to an embodiment of the invention.

FIG. 5 illustrates a timing diagram for a hardware man in the middle propagation delay test according to an embodiment of the invention.

FIGS. 6A-6B illustrate a processor comprising multiple test loops according to an embodiment of the invention.

FIG. 7 illustrates a system on a chip coupled to a hardware man in the middle implementation according to an embodiment of the invention.

FIG. 8 illustrates a method for detecting hardware man in the middle implementations according to an embodiment of the invention.

### DETAILED DESCRIPTION OF SEVERAL EMBODIMENTS

“Man-in-the-middle” (MITM) attacks are a widely known and deployed form of software-based attack where malware is placed between two or more connected pieces of software such that it can spy on all communication between the connected software and impersonate any of the connected software endpoints' commands or responses. MITM attacks may be implemented with or without physical access to systems.

There is also an emerging threat of hardware-based MITM attacks which may be caused by corrupted semiconductor foundries and state-sponsored semiconductor supply-chain tampering, for example. External hardware may be added to a system as a MITM to record and decode internal communication and data formats such as field programmable gate array (FPGA) configuration bitstreams. Due to their low-level proximity to a system, hardware-based MITM attacks can be extremely dangerous.

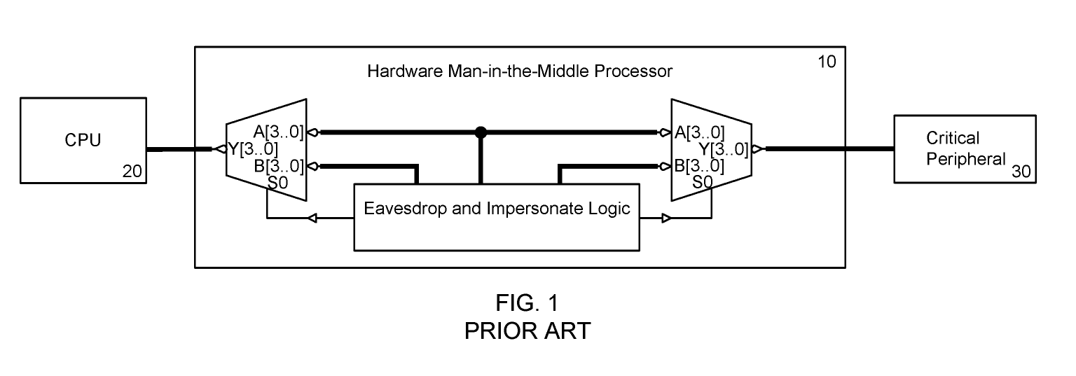

FIG. 1 illustrates an example hardware MITM (HMITM) implementation. An HMITM processor 10 is disposed between a CPU 20 and a peripheral 30. The HMITM processor 10 can electronically impersonate both the peripheral 30 and the CPU 20. The HMITM processor 10 can choose which commands and responses are passed between the CPU 20 and peripheral 30. The HMITM processor 10 could be designed to briefly put endpoints (e.g., CPU 20 and peripheral 30) in detrimental states at randomized periods of time to achieve malicious ends that may be very hard to detect.

HMITM implementations may use, but are not limited to, FPGAs or other programmable logic device (PLD) variants as a central processor due to their flexibility, true hardware-level thread concurrency, and minimal internal signal propagation delay. Microcontrollers and/or CPUs may also be used in some embodiments. HMITM physical implementations can range from visually perceptible foreign semiconductor packages and sockets added to target printed circuit boards to more elaborate and visually undetectable elements.

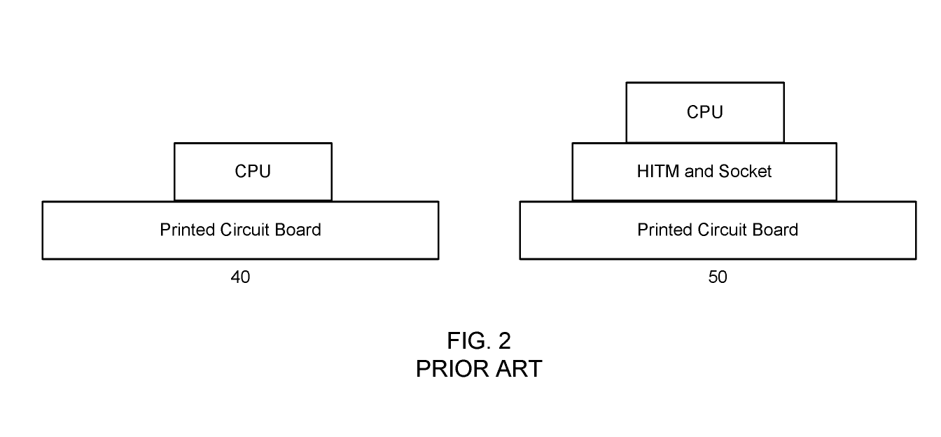

HMITM can be implemented as a retrofit on existing hardware such as computer motherboards through the use of custom sockets and interposer printed circuit boards that raise a target processor so that the HMITM can be mounted underneath it while using the original motherboard's footprint for the target CPU. For example, FIG. 2 shows a standard processor mount 40 and a HMITM implementation mount 50. A socket and interposer board for an HMITM implementation 50 may be used for a variety of processors and processor package types such as ball-grid array (BGA), plastic leadless chip carrier (PLCC), or plastic quad flat pack (PQFP).

Systems and methods described herein may detect HMITM implementations. Since deeply embedded HMITM implementations may be difficult to detect visually, and every PCB or module may not be inspected at the end of a global supply chain, a processor or intelligent module may implement self-tests to detect MITM hardware and/or foreign external connections on critical I/O connections. For example, a processor may include features enabling it to self-detect if an external processor or other circuitry has been attached to it post-production. The processor may self-detect external post-production hardware modifications that attempt to monitor, alter, eavesdrop, substitute, re-purpose, block, or in any other way compromise processor signals. The processor may perform one or more self-tests utilizing integrated resources, such as digital counters, analog comparators, and priority interrupts, to determine if unauthorized external processor connections such as HMITM have been added. HMITM may be connected to a CPU and a peripheral in series, parallel, or both in series and parallel. While parallel connections may be harder to detect, it may be possible to detect their effects, for example by using methods that attempt to alter the signals when specific patterns are detected. Note that while the systems and methods described herein are used to detect HMITM elements, they may also be used to verify the presence of authorized modular hardware that may or may not be connected to the self-detecting system, for example.

In some embodiments, a production design may have optional hardware-based modular add-ons. The firmware for such a modular electronic system may include software flags or hardware jumpers to inform the system controller (CPU) which hardware is attached, but as a failsafe or for implementations where modular add-ons are inserted and removed often in the field of operation, the systems and methods described below may also be used to detect if expected or authorized external hardware attachments are present or not, allowing the system to behave accordingly.

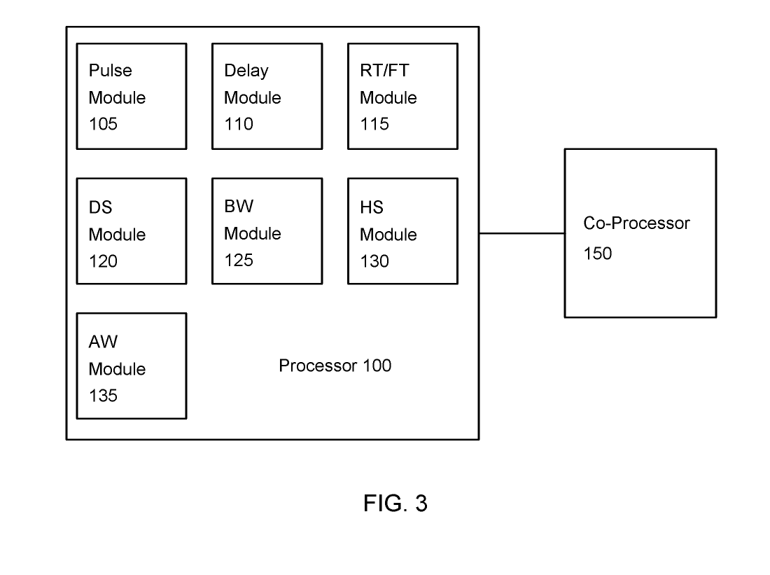

FIG. 3 illustrates a processor 100 comprising self-detection features according to an embodiment of the invention. The processor 100 may include one or more self-test modules configured to detect unauthorized external processor connections (UEPC). For example, the processor 100 may include a pulse module 105, a delay module 110, a rise time/fall time module 115, a drive strength module 120, a bandwidth module 125, a high-speed module 130, an analog waveform module 135, and/or other modules. Furthermore, in some embodiments, one or more external co-processors 150 may be provided. Specific features and functions of these modules are described in greater detail below. UEPC detection modules may each have their own secure internal memory stores for calibration data. The calibration data may be generated through rigorous factory self-tests, for example. The stored calibration data may also include environmental and temporal parameter correction factors, since environmental field parameters may widely vary and components constantly age.

### Propagation Delay Testing

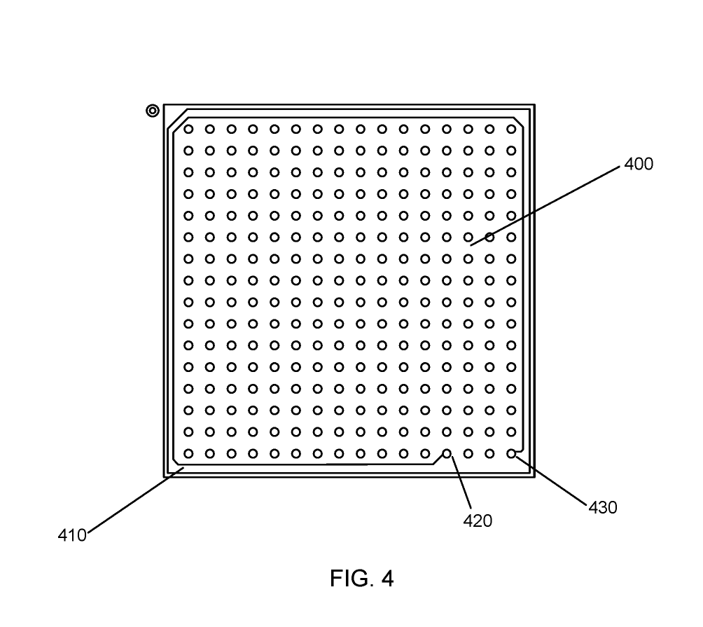

FIG. 4 illustrates a test loop 410 for performing an HMITM propagation delay test and/or other tests according to an embodiment of the invention. A HMITM, such as the one shown in FIG. 1, may cause a slight delay in propagation of signals through it to their intended destination. Based on the semiconductor technology and physical connection implementation used to implement HMITM, the additional propagation delay may be detectable. A covert physical test loop 410 (or loops) may be installed on the motherboard printed circuit board (PCB) where a processor 100 (not shown) is to be installed. The test loop 410 may emanate from a test transmit pin 420 of a CPU footprint pad 400 and may terminate on a test receiver pin 430 or group of receiver pins. The pulse module 105 of the processor 100 may connect to the test loop 410 via the transmit pin 420, and the delay module 110 (and/or other modules described below) may connect to the test loop 410 via the receiver pin 430. In some embodiments, the test loop 410 may be located in a middle layer of the PCB with ground planes above and below it, making it more covert, less accessible for tampering, and/or more immune to electromagnetic noise. For obfuscation and higher testing reliability, additional loops 410 may be used and spread across different layers and using different test transmit pins 420 and receiver pins 430.

The pulse module 105 may generate a pulse that may be carried from the transmit pin 420 through the loop 410 to test the receiver pin 430. The receiver pin 430 may be used to make measurements on the transmitted pulse. To measure the propagation delay of the CPU-generated pulse along the test loop 410 to a receiver pin 430, a counter of the delay module 110 may be initiated at the instant that the transmit pulse is generated. When the pulse reaches a receiver pin 430, the delay module 110 may stop the propagation delay test counter, for example by launching a software interrupt.

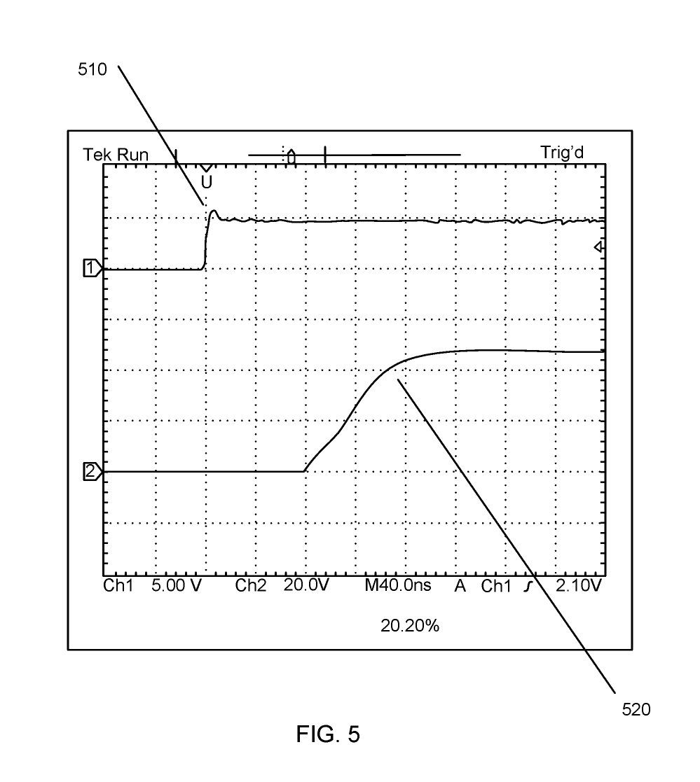

FIG. 5 shows a timing diagram for a HMITM propagation delay test according to an embodiment of the invention. The top signal is a signal at the transmit pin 410, and the bottom signal is the signal at the receiver pin 430. The test count may begin when the pulse 510 is generated. The propagation delay from the time of the pulse 510 to the midpoint of the rise 520 at the receiver pin 430 may be determined, for example. In this sample timing diagram, there is approximately 120 ns of propagation delay from the rise of pulse 510 to the midpoint of the rise of pulse 520.

The expected propagation delay for a CPU or other device may be known. If an HMITM is inserted between the CPU and the motherboard, the propagation count may be larger and may be based on the HMITM propagation time. The delay module 110 may compare a count (or a statistical average of counts) from the propagation delay test(s) to stored factory data from the same tests for the CPU (in some embodiments, the stored factory tests may have been performed over a range of temperatures and possibly other environmental parameters). If the measured count (or averaged counts) differs from the secured factory calibration data by a predetermined threshold, then the delay module 110 may know with a high degree of probability that a HMITM is present.

The delay module 110 may have access to stored calibrated propagation delay times from a test transmit pin to a test receiver pin. This data may be stored securely inside of the CPU or in external secure storage, for example. Since this data may be used to detect tampering, it may be highly secured and encrypted to be safe from tampering and alteration by an attacker. To increase the reliability of the propagation delay test data, additional test loops and transmit and receive test pins may be used. Additionally, other components and processors in the system (e.g., external processors) may be used to relay test pulses.

For instance, consider an HMITM implementation with a microcontroller (MCU) that is generally only capable of a single machine instruction per clock cycle, and that has a fixed port width of 8 GPIO pins. If a CPU implementing methods to detect HMITM has nine test loops (or HMITM fixed port width +1), then the delay counter may include the physical propagation delay added by HMITM and the delay of a machine instruction or more. This may be the case because if 8 of the 9 test loops happened to be routed to the same port of the HMITM, then they may be passed serially through the port with one high-level instruction, for example in an interrupt service routine (“PortX=PortY”). The ninth (or port width +1) test loop may be handled in the next high-level instruction. This may be repeatable and detectable by a CPU implementing the propagation delay test on multiple test loops if the CPU is fast enough to detect the time introduced by the HMITM sensing inputs and changing its port output levels.

Changing the order in which multi-loop propagation delay tests are conducted may also help identify CPU-based HMITM implementations that route signals serially through the CPU with a sequential loop of port-wide output level assignments such as {PORTB=PORTA; PORTD=PORTC; PORTF=PORTE;}. If the first test pulse enters the HMITM on PORTE, then it may be delayed not only by the added loop length of the HMITM but also for a length of time equal to two times the time needed for the HMITM to adjust a port output level in response to a read on another port. This is because an HMITM CPU may sequentially assign the port equivalencies in a loop. For example, if the program starts at the PORTB=PORTA command, the PORTF=PORTE command may be delayed by at least two times the amount of instructions needed to perform a PORT read followed by a PORT write because the PORTD=PORTC command will execute first. This may not be true for an FPGA HMITM, because the FPGA HMITM can assign multiple I/O port equivalencies permanently at the gate level, not requiring sequential command loops like a CPU.

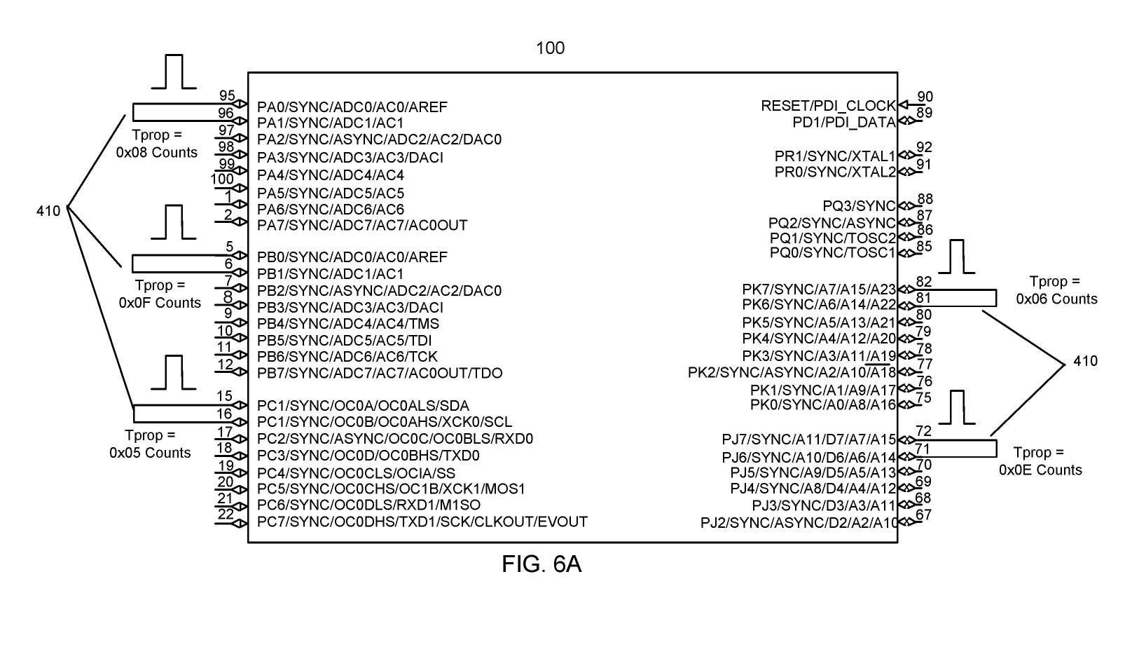

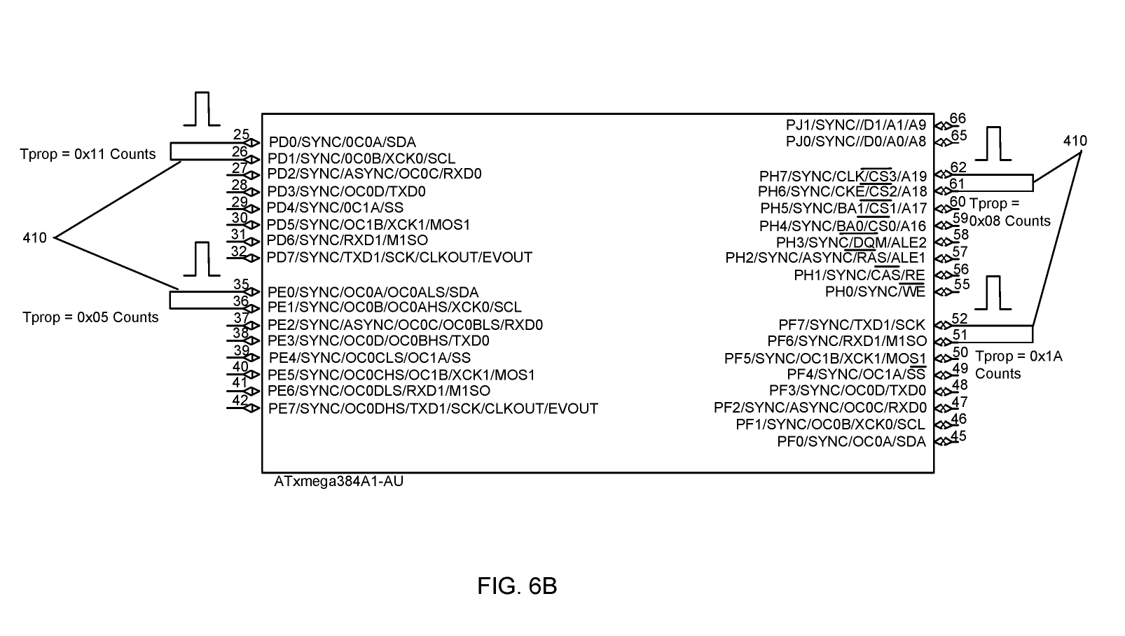

FIGS. 6A-6B illustrate a processor 100 comprising multiple test loops 410 according to an embodiment of the invention. The test loops 410 may be single-ended or differential pair and may be on multiple I/O ports that begin and terminate on the same port. FIGS. 6A-6B also show example propagation times in counts of a hardware counter that starts at zero when the test pulse is generated and ends at count “Tprop” when the test pulse is received at a receiver pin. In some embodiments, each test loop 410 may have a different length from other test loops 410 due to routing constraints, and therefore the test loops 410 may have different propagation times. The insertion of HMITM may increase the value of Tprop, and the delay module 110 counters may have enough speed and resolution to detect the added time for the test to be effective.

A look-up table or other data structure containing all experimentally derived averaged test results and positive HMITM identification thresholds at all operational environmental ranges for the test measurement may be stored in system memory. The delay module 110 may access this data and compare test loop 410 results to the stored data in the field of operation.

Further tests involving test loops 410 are described below. It should be noted that if an attacker were to cut or remove the test loops 410 that emanate from and terminate on the processor 100, then all of the tests would fail. The delay module 110 may detect this failure and thereby detect post-production tampering.

### Rise and Fall Time Testing

A transmitted pulse rise and fall time measurement may be performed by the rise time/fall time module 115 using the same test loop(s) 410 as the propagation test. In some embodiments, a faster external component with finer counting resolution such as a high-speed MCU or FPGA may be used to augment the internal rise time/fall time module 115 for the measurement, as the induced change from HMITM may be less perceptible than the change measured in a propagation delay measurement. For certain circuit board layout scenarios, such as a board with high density connections, an external component dedicated to augmenting HMITM detection placed at a board's edge may be easier to implement than long test loops 410. As shown above in FIG. 5, the received pulse 520 may have a slower rising edge than the transmit pulse 510 with respect to time. The falling edge of the received pulse 520 may similarly be slow relative to the transmit pulse 510. This property of the received pulse 520 may be a function of the test loop 410 transmission line parameters such as parasitic inductance, capacitance, loop resistance, loop length, and/or the drive strength of the transmitting pin. Inserting a HMITM may affect the aforementioned parameters and may thereby change the received pulse's 520 rise and fall times by making them faster or slower.

If the rise time/fall time module 115 includes analog comparators and/or analog-to-digital converters (ADC), for example, the rise and fall times of the received test pulse 520 on the test loop 410 may be computed. If the ADC is fast enough (5-10× the speed of the test pulse slope with respect to time), it may sample the test pulse and calculate the slope of the rise and fall times and compare them to secured calibration data. If the slopes differ by a pre-determined threshold, then it may be likely that the signal path has been altered by an HMITM.

Alternatively, an analog comparator and a counter could be used to count how long it takes the rising and falling edges to transition from one stable voltage reference level to another. The counter and comparator may have enough resolution and speed with respect to the test pulse to make a reliable measurement. Essentially a rise and fall time measurement may be the difference in voltage level with respect to time. The rise time/fall time module 115 may therefore perform the following computation to determine if the rise time of the test pulse has been dramatically altered: Threshold_Rise_Time_Minimum <ΔV/Δt<Threshold_Rise_Time_Maximum, where ΔV is the change in voltage of the test pulse measured over a time range Δt. The fall time alteration determination may be measured and computed in the same way but may use different thresholds because rise and fall times may differ.

A look-up table or other data structure containing experimentally derived averaged results and thresholds for this measurement at various operational environmental ranges may be stored in system memory. The rise time/fall time module 115 may compare the stored data with the measurements from the HMITM detection self-tests.

### Drive Strength Testing

The drive strength module 120 may test a lowest effective drive strength of a test pulse transmission on a test loop 410. Some processor 100 pins may have programmable drive strengths. The minimum drive strength required to register a reception on a test receiver pin at the end of a test loop 410 may be measured and recorded at the factory. In some instances, the insertion of HMITM may cause a minimum powered pulse to not register at the receiver pin 430 and may therefore indicate the presence of HMITM or simply a degraded output driver. Thus, a pulse at or near the recorded minimum drive strength may be transmitted, and the drive strength module 120 may monitor the receiver pin 430 for the pulse. If the pulse is not detected, an HMITM may be present.

Alternately, the HMITM may have a stronger output driver such that pulses having drive strengths lower than the recorded minimum drive strength may still reach the receiver pin 430. Thus, a pulse lower than the recorded minimum drive strength may be transmitted, and the drive strength module 120 may monitor the receiver pin 430 for the pulse. If the pulse is detected, an HMITM may be present.

A look-up table or other data structure containing experimentally derived averaged results and thresholds for this measurement at various operational environmental ranges may be stored in system memory. The drive strength module 120 may compare the stored data with the measurements from the HMITM detection self-tests.

### Test Loop Transmission Line Bandwidth Characterization

The insertion of HMITM may change the transmission line properties of the test loop 410. The induced changes to the test loop's line impedance, bandwidth, parasitic capacitance, and parasitic inductance may contribute to the difference in the test pulse's factory and post HMITM properties that are measured in the methods above. The test loop's transmission line properties may also be measured and stored on-board at the factory.

For instance, the bandwidth of the test loop 410 may be derived if the pulse module 105 can sweep a suitable amount of frequencies on the test loop 410 line such that a bandwidth module 125 monitoring the receiver pin 430 may eventually no longer detect a pulse at some higher frequency due to the impedance of the test loop 410 line (i.e., higher resistance to higher frequencies). Inserting a HMITM may vary the bandwidth of the test loop 410 (for better or for worse) and allow the bandwidth module 125 to detect HMITM presence by comparing the measured signal on the receiver pin 430 to a stored factory bandwidth number and threshold range. Some transmission line parameters of the test loop(s) 410 may also be measured with additional external components such as a dedicated frequency counter device that may measure and digitally write out the frequency detected at its input, for example.

A look-up table or other data structure containing experimentally derived averaged results and thresholds for this measurement at various operational environmental ranges may be stored in system memory. The bandwidth module 125 may compare the stored data with the measurements from the HMITM detection self-tests.

### High-Speed Self-Message Loop Test

Another self-test that could be performed to detect the post-production addition of external hardware may involve a processor 100 messaging itself with the highest data rate possible and comparing the received message to the transmitted message to ensure that the message was not altered. For instance, a processor 100 with multiple Universal Asynchronous Receiver/Transmitter (UART) ports (or equivalent) may use the high-speed module 130 to send a string message, such as “this is a test”, from the transmit port of one UART to the receive port of either the same UART port or another on the same processor 100. The test message or messages may be a known message such that the high-speed module 130 may know what should be received when the test is performed.

The test may be conducted at the highest speed possible on factory hardware at the production facility. The highest successful data rate along with the test message or test messages may be recorded in memory, and the self-message test may be performed in the field at the stored data rate and with the stored messages. If a received self-message does not match the sent message or has errors after repeated attempts, then it may be likely that the signal path has been altered by external hardware. An algorithm may be used to randomize the order of the test messages to be sent when using multiple messages in some embodiments.

This test may not be limited to specific communication ports on the processor 100 configured for conducting self-tests for external hardware detection. Any pin may be able to send out specific data patterns or messages to another pin such that the high-speed module 130 monitoring the receiver pin implements a bit-timing algorithm to extract the pattern or message. This method of implementing custom communication schemes is commonly referred to as “bit-banging”.

### Low-Voltage Analog Waveform Output to a Low-Voltage Sensing Analog-to-Digital (A-to-D) Receiver Input Loop Test

An analog waveform module 135 may use a transmit pin 420 on a test loop 410 to output analog waveforms and a receiver pin 430 on the test loop 410 to sample the analog waveforms at a rate fast enough (˜10×) to see substantial disturbances in the waveforms. If an HMITM on a test loop 410 that implements this test is only a digital I/O path, then it will not detect the portions of an analog waveform that are underneath its voltage sense level such as 2.0 Volts for a “TTL” signal. Therefore analog signals that stay under 2.0V volts may never reach the receiver pin 430 of the test loop 410. The analog waveform module 135 may include a digital loop timer that may be run in conjunction with the start of the analog test pulse. If the pulse is not received at the receiver pin 430 after some timeout time parameter t, then it may be reasonably determined that a HMITM implementation is present.

If an HMITM attack was sophisticated enough to account for an analog input by using an A-to-D input and a D-to-A output, the extra conversion times may be detectable by the analog waveform module 135. Alternately, if an HMITM attack simply passed through the analog waveform on an analog line, the connection may alter the signal enough to be detected. Therefore the analog waveform module 135 may access stored parameters for the expected received analog signals such as amplitude, period, duty-cycle, and/or full-width half-max to compare with the received signals. If any or all of the received parameters are out of predetermined and stored acceptable bounds, then it may be reasoned that a HMITM implementation is the root cause.

### Use of a Test Pulse Echo (or Altered Echo) From an External Component for HMITM Detection

A skilled attacker analyzing a system for HMITM attack vectors may grow suspicious if multiple PCB loops or wires that begin and terminate at a single processor 100 are noticed. If the test loops 410 are embedded in internal PCB layers, then it may be very hard to visually detect them but tedious continuity testing may discover them along with 3D X-ray reverse engineering of the PCB (provided that the PCB design files are not available).

It may improve chances of success in detecting HMITM with PCB test loops 410 if more covert means were used such as test loops 410 that go from an HMITM detector to a another external processor or component in an overall system that is programmed or designed to simply echo a received test pulse or message back to the HMITM detector. For instance, an external microcontroller's UART may be programmed in “echo” mode to relay out whatever it receives in. If the baud rate of the test message is too high for the HMITM test to pass without errors, then the test may fail.

More simply, an external buffer Integrated Circuit (IC) may be wired or programmed to pass an exact replica of a test pulse through itself and back to the device performing an HMITM self-test. If an HMTIM is present, the pulse may have different characteristics as described with respect to the self-tests above.

Furthermore, an external component or device may be used to alter the test pulse or message from the device performing a self-test in a repeatable and recordable way such that the addition of an HMITM may further alter the test pulse in a way detectable by the self-tester using recorded comparison thresholds for the expected return pulse or message.

### Use of a Dedicated External Co-Processor for HMITM Detection

If a processor 100 has a need to detect externally added post-production hardware or an HMITM implementation but cannot spare its own internal resources, or does not have adequate resources to do so, it may employ an external co-processor 150 dedicated to HMITM detection and perhaps other security functions. The two processors 100/150 (and possibly other supporting electronics) may be packaged into a single chip package or module, such that it simply looks like one chip, or System On a Chip (SOC).

This embodiment may provide compartmentalized product and security functions and may allow the use of the best type of processors for HMITM detection. The HMITM detector co-processor 150 may implement all tests described above and may contain the set of modules and/or threshold parameters described above. The co-processor 150 may also include a communication interface with the host processor 100 to allow it to share data and test results with the processor 100.

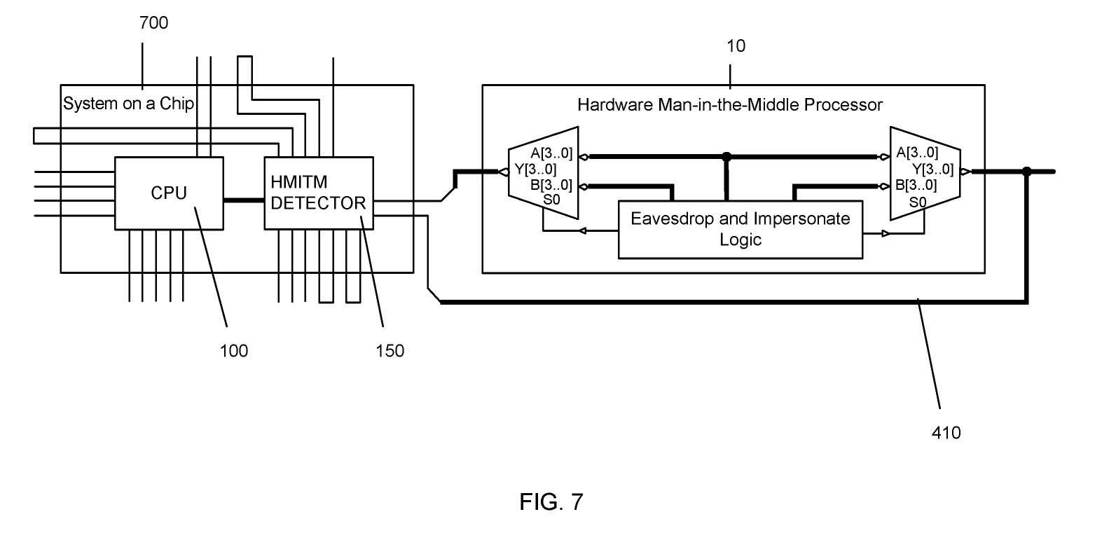

FIG. 7 illustrates a SOC 700 coupled to an HMITM 10 according to an embodiment of the invention. This example SOC 700 implementation includes a processor 100 (CPU) and a co-processor 150 (HMITM Detector), which may be implemented with, for example, a Complex Programmable Logic Device (CPLD), FPGA, MCU, discrete microelectronics, or a combination thereof. To the right of the SOC 700 in FIG. 7 is an HMITM implementation 10 added to a system post-production for malicious intent. For simplicity, only a single loop 410 going through the HMITM 10 is explicitly drawn in this example, although in some embodiments multiple I/O lines from the CPU 100 and/or the HMITM detector 150 may go through the HMITM 10, especially if the attack is socket-based and captures most or all of the I/O lines from the SOC 700.

The single test loop 410 shown emanates from the SOC 700, goes through the HMITM processor 10, and returns to the SOC 700. The HMITM Detector 150 may perform all of its HMITM detection tests at application specific events. The test loops 410 that do not go through the HMITM processor 10 may yield negative detection results, but the loop(s) 410 going through the HMITM processor 10 may have test results that vary from the stored factory thresholds, thus leading to a positive identification of the HMITM 10.

It may be possible that not all available test loops 410 from an HMTIM detector 150 will go through an HMITM 10 if the attack does not capture all of the detector's I/O. Therefore the more test loops 410 that are employed, the higher the chances that one of them may go through an HMITM processor 10 and detect it. A balance may be made between having enough test loops 410 and not being easily detectible to the attacker installing the HMITM 10. Decoy loops, such as loops that go to unused pins on other parts, may be used to disguise an HMITM detector's true purpose from an attacker.

### Use of an Embedded RF Antenna PCB Loop for HMITM Detection

FIG. 4 shows a test loop 410 that emanates from a pin on an HMITM self-detecting processor 100 and terminates on a different pin of the same processor 100. The same tests that are conducted using such physical test loops 410 on a PCB may be emulated with wireless communication such that physical loops are not needed or may be supplemented. If one or more test loops 410 comprise a transmit antenna, and a driver pin of the processor 100 can produce a suitable drive signal at its output, then a designed receive antenna or a chip antenna may detect the transmission out of the transmit antenna loop. If the transmission signal passes through an HMITM device, its received characteristics may be altered in detectable ways when compared to stored comparison threshold data for expected test results. This is because wireless communication may be highly sensitive to transmission line characteristics, in some embodiments much more so than hardwired communication. The presence of an HMITIM processor in the transmit and/or the receive path of a high-frequency radio signal may affect the signal in a detectable manner.

### HMITM Detection Methods

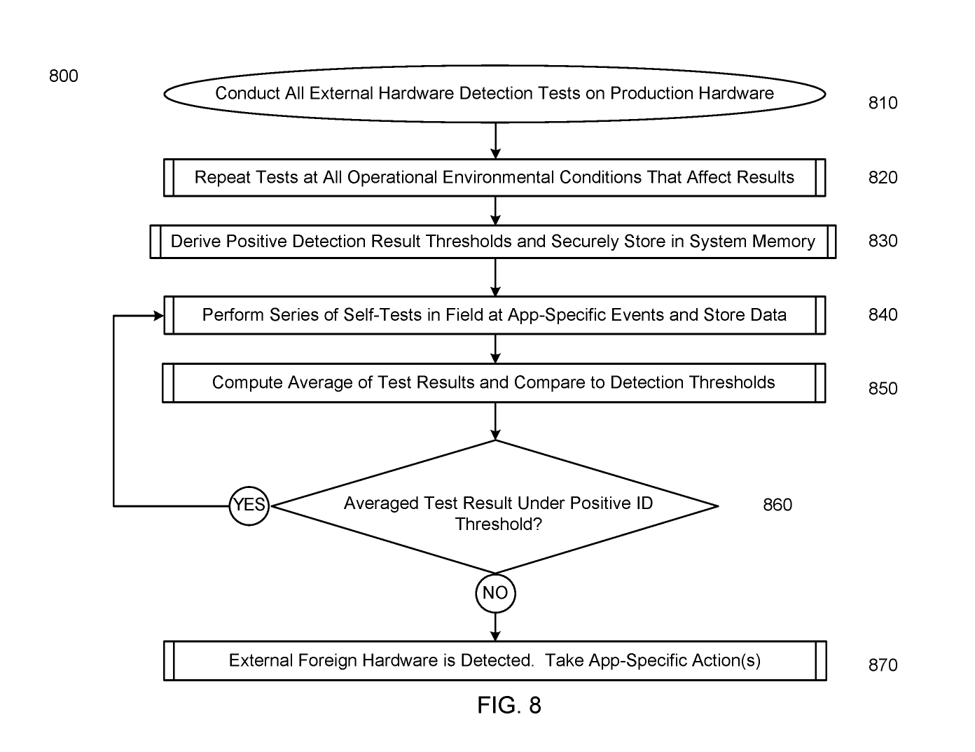

FIG. 8 illustrates a method 800 for detecting hardware man in the middle implementations according to an embodiment of the invention. For a given processor 100, every HMITM self-test that is to be conducted in the field may be performed at the production facility to acquire test data from known authentic hardware 810. The tests may simply be added to the automated test suite of tests that are already conducted on many production systems. Tests may be conducted on all production systems and at all environmental conditions in which a production system may be intended to operate, as test loop characteristics may vary slightly for each production system.

The tests may be repeated 820. Enough tests may be conducted to compute and store statistically averaged detection thresholds for each self-test.

Thresholds for each test may also be set 830. The thresholds for any self-test may be a range of minimum and maximums that an averaged result must be between, or may be an absolute min or max that an averaged result must be either above or below, for example. The thresholds for each test may be chosen to be large enough to minimize false positive identification. If a test cannot yield such a threshold, then it may not be included for the processor 100. Also, it may be necessary to store unique detection thresholds for particular environmental ranges for some processors 100 in some embodiments. For instance, some threshold parameter “A1” may be stored for “Test A” for a temperature range of 0-20 degrees Celsius because it has been determined that temperature can affect the test result. For this test, if the averaged result of Test A is less than the experimentally derived threshold value for the test, then the test may conclude that no external hardware has interfered with the measurement. A threshold parameter “A2” may then be stored for Test A for a temperature range of 21-40 degrees Celsius. If the system self-performed Test A at 25 degrees Celsius (granted that the system can sense temperature accurately), then it may compare its averaged result to threshold A2 instead of threshold A1 to make its decision. A look-up table or other data structure containing experimentally derived positive HMITM identification thresholds for HMITM self-detection measurements at all operational environmental ranges of interest may be stored, as noted above, for the production facility self-tests. With a stored program of self-tests and a look-up table containing the necessary positive HMITM identification threshold parameters, the system may be able to perform the HMITM detection self-tests in the field.

Self-tests may be performed at application or deployment specific events such as power-ups and/or system resets, time-based events, sensor-based events, and/or other events 840. Each self-test may be performed multiple times to obtain an average result. Each averaged result may be compared to the stored threshold value(s) in memory 850. If an averaged HMITM detection self-test result yields a positive identification of added external hardware 860, then appropriate application-specific action may be taken 870. This may include, but is not limited to, erasing sensitive data, not communicating on certain communication ports, not responding to certain commands, alerting a system administrator, or not operating at all until an unlock procedure is enacted.

Application-specific rules may also be generated to require positive detection results on either all, one, or multiple HMITM detection self-tests, and perhaps even at multiple environmental conditions, before a final decision on whether external hardware is present may be made. Certain tests may also be weighted heavier than others in a composite score method. For instance, a propagation delay test with a result of positive HMITM detection may weigh a 2.0, while every other test with the same result may only weigh 1.0. In this weighted scheme, a final score of 3.0 may be necessary and sufficient for the system to self-determine that external hardware has been added.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments.

In addition, it should be understood that any figures that highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A system for detecting hardware modifications comprising:
a test loop terminating at a transmit pin and a receiver pin of a processor footprint pad; and
a processor coupled to the test loop via the transmit pin and the receiver pin, the processor being configured to:
cause a signal to be transmitted to the test loop from the transmit pin;
receive a modified signal from the test loop at the receiver pin; and
analyze the modified signal to detect a hardware modification in communication with the test loop based on the modified signal.

2. The system of claim 1, further comprising a plurality of test loops terminating at a plurality of transmit pins and receiver pins of the processor footprint pad; wherein
the processor is coupled to each test loop via the transmit pins and the receiver pins, and the processor is further configured to:
cause a signal to be transmitted to each test loop from each transmit pin;
receive a modified signal from each test loop at each receiver pin; and
analyze each modified signal to detect the hardware modification in communication with at least one of the test loops based on at least one of the modified signals.

3. The system of claim 1, wherein:
the test loop terminates at a plurality of transmit pins, a plurality of receiver pins, or a combination thereof; and
the processor is coupled to the test loop via the plurality of transmit pins, the plurality of receiver pins, or the combination thereof, the processor being further configured to:
cause the signal to be transmitted to the test loop from at least one of the plurality of transmit pins;
receive the modified signal from the test loop at at least one of the plurality of receiver pins; or
a combination thereof.

4. The system of claim 1, wherein the processor comprises a processor being tested for the hardware modification, a co-processor coupled to the processor being tested for the hardware modification, or a combination thereof.

5. The system of claim 1, further comprising a memory coupled to the processor, wherein the processor is configured to analyze the modified signal to detect the at least one hardware modification by comparing the modified signal with data stored in the memory.

6. The system of claim 5, wherein the data comprises prior test loop analysis data experimentally derived when the hardware modification is known to be absent.

7. The system of claim 1, wherein the transmitted signal comprises:
a pulse signal having a known rise time, a known fall time, or a known rise time and fall time;
a signal having a known drive strength;
a signal that sweeps across a plurality of frequencies or a series of signals each at a different one of the plurality of frequencies;
a signal having a known data content;
an analog waveform signal; or
a combination thereof.

8. The system of claim 1, wherein the processor comprises a pulse module configured to transmit the signal to the test loop from the transmit pin, an analog waveform module configured to transmit the signal to the test loop from the transmit pin, or a combination thereof.

9. The system of claim 1, wherein the processor is configured to analyze the modified signal to detect the at least one hardware modification by determining that a rise time of the modified signal is different from an expected rise time, a fall time of the modified signal is different from an expected fall time, or a combination thereof.

10. The system of claim 1, wherein the processor is configured to analyze the modified signal to detect the at least one hardware modification by determining that a drive strength of the modified signal is different from an expected drive strength.

11. The system of claim 1, wherein the processor is configured to analyze the modified signal to detect the at least one hardware modification by determining that a bandwidth parameter of the modified signal is different from an expected bandwidth parameter.

12. The system of claim 1, wherein the processor is configured to analyze the modified signal to detect the at least one hardware modification by determining that a data content of the modified signal is different from an expected data content.

13. The system of claim 1, wherein the processor is configured to analyze the modified signal to detect the at least one hardware modification by determining that a waveform parameter of the modified signal is different from an expected waveform parameter.

14. The system of claim 1, wherein:
the processor comprises an external component coupled to a processor being tested for the hardware modification;
the test loop is coupled to the external component and configured to transmit the signal to the external component;
the external component is configured to transmit the modified signal to the receive pin via the test loop in response to receiving the signal; and
the processor is configured to analyze the modified signal to detect the at least one hardware modification by determining that a data content of the modified signal is different from an expected data content.

15. The system of claim 1, wherein the test loop comprises:
a first antenna coupled to the transmit pin; and
a second antenna coupled to the receiver pin.

16. A method for detecting hardware modifications comprising:
causing, with a processor, a signal to be transmitted from a transmit pin of a processor footprint pad to a test loop terminating at the transmit pin and a receiver pin of the processor footprint pad, the processor being coupled to the test loop via the transmit pin and the receiver pin;
receiving, with the processor, a modified signal from the test loop at the receiver pin; and
analyzing, with the processor, the modified signal to detect a hardware modification in communication with the test loop based on the modified signal.

17. The method of claim 16, further comprising:
causing, with the processor, a signal to be transmitted from each of a plurality of transmit pins of the processor footprint pad to a plurality of test loops terminating at the transmit pins and a plurality of receiver pins of the processor footprint pad, the processor being coupled to each test loop via each transmit pin and each receiver pin;
receiving, with the processor, a modified signal from each test loop at each receiver pin; and
analyzing, with the processor, each modified signal to detect the hardware modification in communication with at least one of the test loops based on at least one of the modified signals.

18. The method of claim 16, further comprising:
causing, with the processor, the signal to be transmitted to the test loop from at least one of a plurality of transmit pins;
receiving, with the processor, the modified signal from the test loop at at least one of a plurality of receiver pins; or
a combination thereof.

19. The method of claim 16, wherein the processor comprises a processor being tested for the hardware modification, a co-processor coupled to the processor being tested for the hardware modification, or a combination thereof.

20. The method of claim 16, further comprising wherein analyzing, with the processor, the modified signal to detect the at least one hardware modification comprises comparing the modified signal with data stored in a memory coupled to the processor.

21. The method of claim 20, wherein the data comprises prior test loop analysis data experimentally derived when the hardware modification is known to be absent.

22. The method of claim 16, wherein the transmitted signal comprises:
a pulse signal having a known rise time, a known fall time, or a known rise time and fall time;
a signal having a known drive strength;
a signal that sweeps across a plurality of frequencies or a series of signals each at a different one of the plurality of frequencies;
a signal having a known data content;
an analog waveform signal; or
a combination thereof.

23. The method of claim 16, further comprising:
transmitting, with a pulse module of the processor, the signal to the test loop from the transmit pin;
transmitting, with an analog waveform module of the processor, the signal to the test loop from the transmit pin; or
a combination thereof.

24. The method of claim 16, wherein analyzing, with the processor, the modified signal to detect the at least one hardware modification comprises determining that a rise time of the modified signal is different from an expected rise time, a fall time of the modified signal is different from an expected fall time, or a combination thereof.

25. The method of claim 16, wherein analyzing, with the processor, the modified signal to detect the at least one hardware modification comprises determining that a drive strength of the modified signal is different from an expected drive strength.

26. The method of claim 16, wherein analyzing, with the processor, the modified signal to detect the at least one hardware modification comprises determining that a bandwidth parameter of the modified signal is different from an expected bandwidth parameter.

27. The method of claim 16, wherein analyzing, with the processor, the modified signal to detect the at least one hardware modification comprises determining that a data content of the modified signal is different from an expected data content.

28. The method of claim 16, wherein analyzing, with the processor, the modified signal to detect the at least one hardware modification comprises determining that a waveform parameter of the modified signal is different from an expected waveform parameter.

29. The method of claim 16, further comprising:
transmitting, with the test loop, the signal to an external component coupled to a processor being tested for the hardware modification; and
transmitting, with the external component, the modified signal to the receive pin via the test loop in response to receiving the signal;
wherein analyzing, with the processor, the modified signal to detect the at least one hardware modification comprises determining that a data content of the modified signal is different from an expected data content.

30. The method of claim 16, wherein:
causing, with the processor, the signal to be transmitted from the transmit pin to the test loop comprises transmitting the signal with a first antenna coupled to the transmit pin; and
receiving, with the processor, the modified signal from the test loop at the receiver pin comprises receiving the signal with a second antenna coupled to the receiver pin.
